(19) United States
(12) Patent Application Publication
(10) Pub. No.: US 2025/0287139 A1
(43) Pub. Date: Sep. 11, 2025

(54) MEMS Speaker Architecture

(71) Applicant: Apple Inc., Cupertino, CA (US)

(72) Inventors: Onur I. Ilkorur, Santa Clara, CA (US); Gokhan Hatipoglu, Milpitas, CA (US); Peter C. Hrudey, San Jose, CA (US); Christopher Wilk, Los Gatos, CA (US)

(21) Appl. No.: 19/054,507

(22) Filed: Feb. 14, 2025

Related U.S. Application Data
(60) Provisional application No. 63/563,249, filed on Mar. 8, 2024.

(51) Int. Cl. H04R 1/24; H04R 19/02

(52) U.S. Cl. CPC H04R 1/24; H04R 19/02; H04R 2201/003; H04R 2499/11

(57) ABSTRACT

A microelectromechanical transducer assembly comprising: an enclosure defining an interior chamber and an opening from the interior chamber to a surrounding ambient environment; a first sound radiating member operable to produce a first frequency; and a second sound radiating member arranged parallel to the first radiating member and operable to produce a second frequency that in combination with the first frequency generates an audible sound output.

### CROSS-REFERENCE TO RELATED APPLICATION

This application is a non-provisional application of co-pending U.S. Provisional Patent Application No. 63/563,249, filed Mar. 8, 2024, and incorporated herein by reference.

### FIELD

An aspect of the disclosure is directed to a microelectromechanical systems (MEMS) speaker architecture that uses ultrasonic modulation and demodulation techniques to generate audible sound. Other aspects are also described and claimed.

### BACKGROUND

Portable communications or listening devices (e.g., smart phones, earphones, etc.) have within them one or more transducers that convert an input electrical audio signal into a sound pressure wave output that can be heard by the user, or a sound pressure wave input into an electrical audio signal. The transducer (e.g., a speaker) can be used to, for example, output sound pressure waves corresponding to the voice of a far end user, such as during a telephone call, or to output sound pressure waves corresponding to sounds associated with a game or music the user wishes to play. Due to the relatively low profile of the portable devices, the transducers also have a relatively low profile, which in turn, can make it difficult to maintain optimal sound quality.

### SUMMARY

An aspect of the disclosure is directed to a microelectromechanical systems (MEMS) transducer or speaker architecture that uses ultrasonic modulation and demodulation techniques to generate audible sound. Ultrasonic modulation and demodulation speaker techniques generate an audible sound from modulated ultrasound using an amplitude-modulated ultrasonic wave that follows the amplitude of the intended audio signal. The modulated ultrasound is demodulated to produce the intended audible sound output. In some aspects, the MEMS transducer or speaker disclosed herein may include chip-scale unit cells, transducers or actuators that may be arranged in an array to form the speaker package or module. Sound may be generated by each unit cell and/or the array of unit cells using ultrasonic modulation. In some aspects, the array may include at least two or more unit cells, transducers and/or actuators that are arranged side-by-side in an X-Y plane. In some aspects, one of the transducers or actuators may output an ultrasonic carrier frequency and another of the transducers or actuators may be a modulator. In still further aspects, each unit cell, transducer or actuator may include a carrier beam and a modulator beam that work together to create audible sound in air using ultrasound and the non-linearity of air. In other aspects, the cell, transducer or actuator may include two or more pistonic actuators of any shape moving out of plane to produce carrier and modulator frequencies. The actuation of the beams or pistonic actuators may be electrostatic or piezoelectric. In some aspects, the beams or pistonic actuators may be formed from MEMS materials (e.g., polysilicon, silicon nitride, silicon dioxide or polymeric materials) using MEMS processing techniques. The audible sound created using the techniques disclosed herein may have improved directivity, for example, at low frequencies.

In some aspects, the disclosure is directed to a microelectromechanical transducer assembly including an enclosure defining an interior chamber and an opening from the interior chamber to a surrounding ambient environment; a first sound radiating member operable to produce a first frequency; and a second sound radiating member arranged parallel to the first radiating member and operable to produce a second frequency that in combination with the first frequency generates an audible sound output. In some aspects, each of the first sound radiating member and the second sound radiating member comprise a cantilever beam having a first end attached to an interior surface of the enclosure and a second end that is operable to deform to produce the first frequency or the second frequency. In other aspects, the first sound radiating member comprises a carrier beam that produces only the first frequency. In still further aspects, the first frequency comprises a carrier frequency within an ultrasonic frequency range. In some aspects, the second sound radiating member comprises a modulator beam and the second frequency comprises a modulator frequency that is different from the first frequency. In some aspects, at least one of the first sound radiating member or the second sound radiating member comprises a piezoelectric beam. In some aspects, the piezoelectric beam comprises a first passive layer comprising silicon and a second active layer comprising potassium sodium niobate. In still further aspects, the at least one of the first sound radiating member or the second sound radiating member comprises a sound radiating surface that runs perpendicular to an axis through the opening. At least one of the first sound radiating member or the second sound radiating member comprises an electrostatic plate. In some aspects, the electrostatic plate comprises a number of arms extending from a perimeter of the electrostatic plate and the number of arms attach the electrostatic plate to an interior surface of the enclosure. At least one of the first sound radiating member or the second sound radiating member comprises a sound radiating surface that runs parallel to an axis through the opening. In some aspects, the enclosure defines a first transducer unit comprising the first sound radiating member and the second sound radiating member, and the first transducer unit is part of an array of other transducer units that generate an audible sound output. In still further aspects, the opening is the only opening from the interior chamber to the surrounding ambient environment.

In other aspects, the disclosure is directed to an electronic device comprising: a microelectromechanical transducer assembly having enclosure defining an interior chamber and an opening from the interior chamber to a surrounding ambient environment; a first sound radiating member operable to produce a first frequency; and a second sound radiating member arranged parallel to the first radiating member and operable to produce a second frequency that in combination with the first frequency generates an audible sound output. In some aspects, each of the first sound radiating member and the second sound radiating member comprise a beam having a first end attached to an interior surface of the enclosure and a second end that is operable to deform to produce the first frequency or the second frequency. In some aspects, the first sound radiating member comprises a carrier beam that produces only the first frequency within an ultrasonic frequency range. In other aspects, the second sound radiating member comprises a modulator beam and the second frequency comprises a modulator frequency that is different from the first frequency. In some aspects, at least one of the first sound radiating member or the second sound radiating member comprises a piezoelectric beam. In other aspects, the piezoelectric beam comprises a sound radiating surface that runs perpendicular to an axis through the opening. In some aspects, at least one of the first sound radiating member or the second sound radiating member comprises an electrostatic plate. In still further aspects, the electrostatic plate comprises a number of arms extending from a perimeter of the electrostatic plate and the number of arms attach the electrostatic plate to an interior surface of the enclosure. In some aspects, the at least one of the first sound radiating member or the second sound radiating member comprises a sound radiating surface that runs parallel to an axis through the opening. In some aspects, the microelectromechanical transducer assembly is a first microelectromechanical transducer assembly that is part of an array of other microelectromechanical transducer assemblies that are combined to generate an audible sound output.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect in this disclosure are not necessarily to the same aspect, and they mean at least one.

FIG. 1 illustrates a perspective view of one aspect of a transducer assembly.

FIG. 2 illustrates a cross-sectional side view of the transducer assembly of FIG. 1 along line 2-2′.

FIG. 3 illustrates a cross-sectional side view of the transducer assembly of FIG. 1 along line 2-2′.

FIG. 4 illustrates a top plan view of an aspect of the transducer assembly of FIG. 1.

FIG. 5 illustrates a cross-sectional side view of FIG. 4 along line 5-5′.

FIG. 6 illustrates a top plan view of another aspect of a transducer assembly of FIG. 1.

FIG. 7 illustrates a cross-sectional side view of the transducer assembly of FIG. 6.

FIG. 8 illustrates a cross-sectional side view of the transducer assembly of FIG. 6.

FIG. 9 illustrates a perspective view of another aspect of a transducer assembly.

FIG. 10 illustrates a cross-sectional side view of the transducer assembly of FIG. 9.

FIG. 11 illustrates a cross-sectional side view of the transducer assembly of FIG. 9.

FIG. 12 illustrates a block diagram of one aspect of an electronic device within which the transducer assembly of FIG. 1-FIG. 11 may be implemented.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

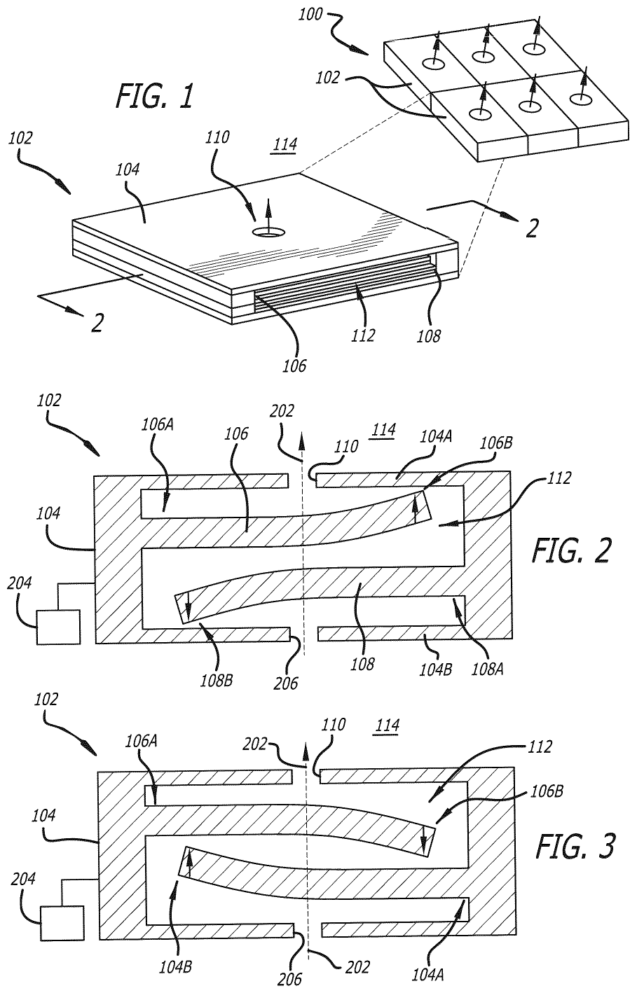

FIG. 1 illustrates a perspective view of one aspect of a transducer assembly. Transducer assembly 100 may include an array or other arrangement of a number of transducer units or cells 102. For example, assembly 100 may include an array of side-by-side microelectromechanical system (MEMS) transducer units or cells 102. Sound may be generated by cells 102 using ultrasonic modulation. In some aspects, the transducer units or cells 102 may be MEMS electro-acoustic transducers such as speakers which convert electrical signals into an audible output that can be output from a device within which transducer assembly 100 is integrated. In other aspects, transducer units or cells 102 may convert sound into an electrical audio signal, and may be referred to as a microphone. Each of the transducer units or cells 102 may be separate units that operate independently of one another to generate sound, but may be combined to form an array and their sound outputs combined to produce an overall desired acoustic output. As can be seen from the magnified view of one of the units or cells 102, each unit or cell 102 may include an enclosure or housing 104. Enclosure or housing 104 may be a relatively rigid structure that supports and/or encloses some or all of the components of units or cells 102. In some aspects, housing 104 may support or enclose, or otherwise be coupled to, only the transducer components (e.g., a transducer module). Housing 104 may, in some cases, include a number of walls or portions that are sealed together to create a cavity or interior chamber 112 for containing the transducer components. In some aspects, the portions of walls may be considered fixed structures that can be snap-fit, welded, adhered or attached in a sealed manner together using some other mechanism or process along their interfacing surfaces to form housing 104. The only opening from the interior chamber formed by housing 104 to the ambient environment may be opening 110. Opening 110 may, in some aspects, be considered an acoustic or sound output opening that outputs sound (as indicated by the arrow) generated within the interior cavity of transducer cell 102 by the transducer components to the surrounding ambient environment 114 (e.g., to the listener). The interior cavity 112 therefore provides an acoustic pathway for sound generated by the transducer components to the ambient environment 114 through opening 102 and may be considered a front volume chamber. In some aspects, the entire cavity may be considered a front volume chamber, and a back volume chamber or separate acoustic chamber behind the transducer components, may be omitted.

The sound output through opening 110 may be generated by moving, deforming or radiating members 106 and/or 108 suspended within the interior chamber of housing 104 using ultrasonic modulation/demodulation techniques. Members 106, 108 may have a fixed portion attached, or integrally formed with, an interior side of housing 104 and a moving portion that moves or vibrates to produce, generate or otherwise radiate a sound that can be output to the ambient environment. In some aspects, members 106, 108 may be cantilever type beams, plates or the like that are attached (or integrally formed with) at the fixed end to an interior surface of housing 104 and extend from the surface to a free end that is free to move, vibrate or deflect to produce the sound output. Members 106, 108 may therefore also be referred to herein as cantilever beams or plates. In other aspects, member 106 and/or member 108 may have arm liked fixed portions attached at different locations around the perimeter to housing 104 and center movable, vibrating or deflecting portion that moves in a piston like motion to produce the sound output. In some aspects, one of members 106 and/or 108 may be considered a carrier member or beam that is only responsible for generating a single frequency (e.g., the carrier frequency). The other member or beam 106 and/or 108 may be considered a modulator beam that is free to generate other frequencies. An excursion clearance is provided around members or beams 106, 108 so that when one or more of members or beams 106, 108 are energized, they can achieve the desired amount of excursion (e.g., within microns) to produce sound using ultrasonic modulation/demodulation techniques without contacting one another and/or the interior surface of housing 104. For example, the excursion clearance around all sides of members or beams 106 and/or 108 may be the same as or less than a thickness of each of members or beams 106 and/or 108 (e.g., four microns or less). In this aspect, in the closed cavity formed by housing 104 around members or beams 106, 108, members or beams 106, 108 occupy a majority of the air space within the cavity and the clearance between the beams and housing (e.g., packaging) is relatively small. To maintain this compact configuration, as previously discussed, the entire interior cavity may connect to opening 110 and be considered a front volume chamber, and a back volume chamber may be omitted. It may further be understood that the purpose of the reduced air space round beams 106, 108 is to further maintain an opening 110 having the reduced size required to bring the air to a nonlinear state. The air must be to a nonlinear state or region for the assembly to operate to produce audible sound using ultrasound and the nonlinearity of air. Once the nonlinear state is obtained, the carrier beam 106 and modulator beam 108 work together to output lower and higher frequencies mirrored from the carrier beam frequency into the nonlinear air medium to produce the audible frequency (or difference frequency) that is output by the assembly to the ambient environment. The generated sound may be output through the opening 110 to the ambient environment.

Representatively, FIG. 2 and FIG. 3 illustrate a representative operation of unit or cell 102 to produce audible sound using ultrasonic modulation/demodulation techniques. In particular, FIG. 2 and FIG. 3 illustrate cross-sectional views along line 2-2′ of FIG. 1. From these views, it can be seen that members or beams 106 and 108 may be generally understood as having radiating surfaces that are oriented or running parallel to one another and top/bottom housing walls 104A, 104B (in the resting state), and perpendicular to a radiation or sound output axis 202 running through opening 110. Beam 106 may be attached at a fixed end 106A to an interior side wall of housing 104 and extend across the interior cavity to a free end 106B that is free to deflect in a direction along the radiation axis 202. Beam 108 may be attached at a fixed end 108A to the opposite interior side wall of housing 104 and extend across the interior cavity to a free end 108B that is free to deflect in a direction along the radiation axis 202. In some aspects, beams 106 and 108 may be piezoelectric beams which deflect or deform toward or away from one another when they are energized, for example, upon application of a carrier or modulating signal 204. Representative, FIG. 2 illustrates beams 106 and 108 energized so that their free ends 106B, 108B deflect or deform away from one another as illustrated by the arrows. FIG. 3 illustrates beams 106 and 108 energized so that their free ends 106B, 108B deflect or deform toward one another as illustrated by the arrows. As previously discussed, the excursion space provided around beams 106, 108 is sufficient to prevent beams 106, 108 from contacting one another or an interior surface of housing 104. For example, in some aspects, the cavity dimensions may be approximately 5 microns larger than the x and y dimensions of beams 106, 108, and the Z height dimension may have a maximum excursion clearance or space to prevent interference while still keeping the air volume as small as possible. Beams 106, 108 may be driven to deflect or deform as shown to produce carrier and modulator frequencies, respectively, within ranges desirable for producing audible sound using ultrasonic modulation/demodulation. For example, in some aspects, the beam 106 may be considered a carrier beam that produces a carrier beam frequency that may be within an ultrasonic frequency range of approximately 38 kilohertz, and beam 108 may be considered a modulator beam that produces a modulator frequency that may be within a different ultrasonic frequency range, or a range of from 38 kilohertz plus up to 20 kilohertz. It should further be understood that in other aspects, beam 106 may be considered a carrier beam that produces the carrier frequency and beam 108 may be considered a modulator beam that produces the modulator frequency. In addition, in some aspects, an opening 206 may further be formed through bottom housing wall 104B for efficiency improvement. Opening 206 may be formed along the axis 202 as shown, or may be formed in other parts of wall 104B.

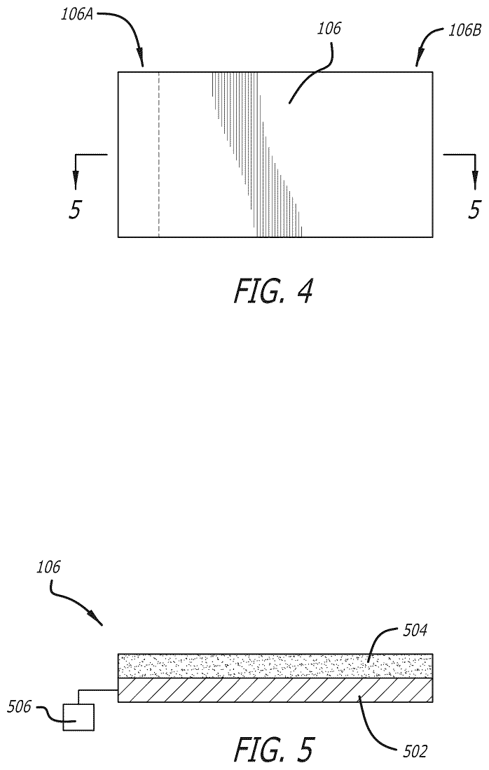

Beam 106 and beam 108 may have any number of shapes and sizes suitable for producing the carrier and modulator frequencies desired. FIG. 4 illustrates a top plan view of one representative beam shape. Representatively, a top view of beam 106 having a rectangular shaped beam is illustrated in FIG. 4. In this aspect, the fixed end 106A and the free end 106B may be formed at the ends or sides of beam 106 to maximize the surface area that deforms when beam 106 is energized. For example, in some aspects, the area defined by the dashed line 106A may be the fixed end that does not deform and the remaining length of beam 106 from the dashed line to free end 106B is free to deform upon application of the desired signal. The length, width and/or height of beam 106 may be optimized or otherwise selected to achieve and/or improve acoustic performance at different frequencies (e.g., low frequency performance). Although not shown, beam 108 may have a similar or same rectangular shape as that of beam 106. It is further contemplated that one or more of beams 106, 108 may have another shape, for example, a square shape, a triangular shape, a circular shape, an elongated shape, or any other shape that defines a sufficient radiating surface area capable of deforming as desired once energized.

In addition, as previously discussed, in some aspects, the beams may be piezoelectric beams or plates capable of deforming when energized. FIG. 5 illustrates a cross-sectional view along line 5-5′ of beam or plate 106 of FIG. 4. From this view, it can be seen that beam 106 may include an active piezoelectric layer 502 and a passive layer 504. In some aspects, the passive layer 504 may be formed by a silicon material or substrate and the active piezoelectric layer 502 may be, for example, a potassium sodium niobate (KNN) layer or film deposited or laminated on the silicon layer. The active piezoelectric layer 502 can be driven to deform upon application of a signal or voltage 506. Representatively, a first signal or voltage 506 may be applied to cause layer 502 to deform in an upward direction, and in turn beam 106 to deform in the upward direction as illustrated in FIG. 2. A second signal or voltage 506 may be applied to cause layer 502 to deform in a downward direction, and in turn beam 106 to deform in the downward direction as illustrated in FIG. 3. Although not shown, beam 108 may similarly be formed of an active piezoelectric layer and a passive layer, and operate in a similar manner as beam 106. It is further contemplated that in other aspects, beams 106, 108 may be electrostatic beams that are actuated or driven using electrostatic forces generated by any suitable mechanism.

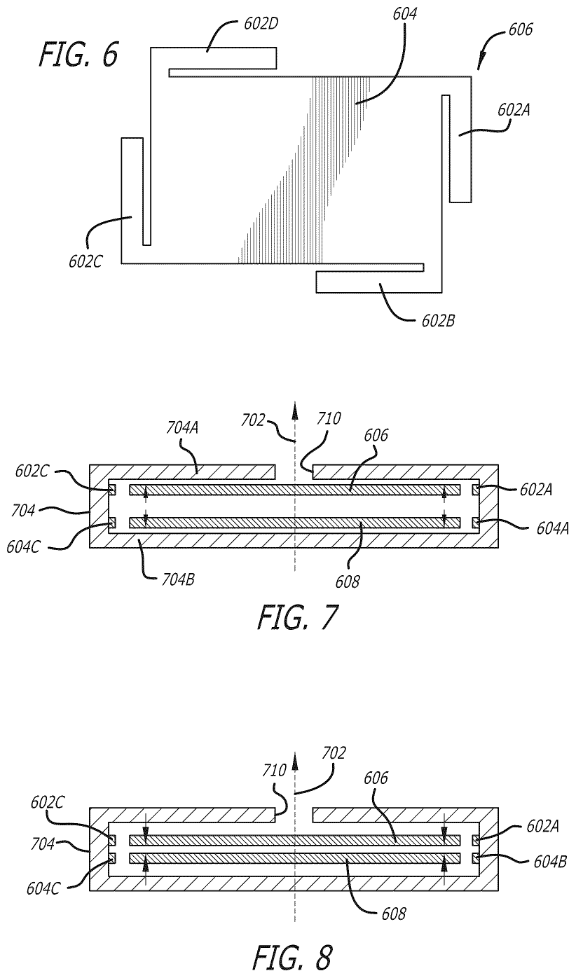

FIG. 6 illustrates a top plan view of an alternative beam or plate that is contemplated for use in the assembly of FIG. 1. Representatively, FIG. 6 illustrates a beam or plate 606 having a number of fixed arms portions 602A, 602B, 602C, 602D that suspend a radiating portion 604 from the housing (e.g., housing 104). The radiating portion 604 may have a polygonal shape, such as a square or rectangular shape, and may be suspended by fixed arm portions 602A-D such that it moves in a piston like manner as illustrated in FIGS. 6-7. Representatively, fixed arm portions 602A-D may extend from a perimeter of radiating portion 604, for example, from each corner of radiating portion 604. Fixed arm portions 602A-D may provide a flexible connection between the housing and radiating portion 604 so that radiating portion 604 can move relative to the housing to produce a carrier and/or modulating frequency as previously discussed. Although not illustrated in this view, it should be understood that a second beam or plate similar to beam or plate 606 may be arranged below and parallel to beam or plate 606 so that the assembly includes both a carrier and a modulator beam as discussed in reference to FIG. 1.

Representatively, FIG. 7 and FIG. 8 illustrate cross-sectional side views of a transducer cell or unit incorporating a pair of beams or plates as discussed in reference to FIG. 6. From this view, it can be seen that the transducer cell or unit includes a housing 704 having an opening 702 for sound output as previously discussed. Beams or plates 606 and 608 are arranged within housing 704 such that their radiating surfaces (e.g., portions 604) are parallel to one another and the top and bottom housing walls 704A, 704B, and perpendicular to the radiation axis 702. Beams or plates 606, 608 are shown attached to housing 704 by their respective fixed arm portions 602A, 602C and 604A, 604C. In this aspect, upon application of a signal or voltage, beams or plates 606, 608 may move as illustrated by the arrows in a pistonic like motion toward or away from one another. Representatively, FIG. 7 illustrates beams or plates 606, 608 moving away from one another (e.g., in a direction parallel to radiation axis 702). On the other hand, FIG. 8 illustrates beams or plates 606, 608 moving toward one another (e.g., in a direction parallel to the radiation axis 702). In some aspects, one of beams 606 and/or 608 may be considered a carrier beam that is responsible for generating a single frequency (e.g., the carrier frequency). The other beam 606 and/or 608 may be considered a modulator beam that is free to generate other frequencies. An excursion clearance is provided around beams 606, 608 so that when one or more of beams 606, 608 are energized, they can achieve the desired amount of excursion (e.g., within microns) to produce sound using ultrasonic modulation/demodulation techniques as previously discussed. It is further contemplated that in some aspects, plates or beams 606, 608 may be electrostatic beams that are actuated or driven using electrostatic forces generated by any suitable mechanism. Alternatively, plates or beams 606, 608 may be piezoelectric beams driven by a signal or voltage similar to beams 106, 108 previously discussed in reference to FIGS. 2-5.

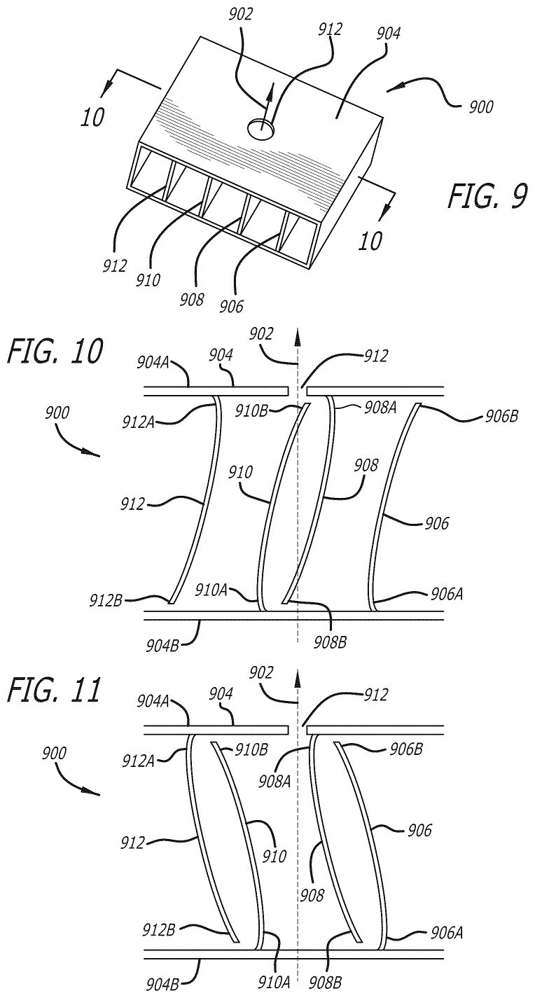

FIG. 9 illustrates a perspective view of another aspect of a transducer assembly. Similar to the previously discussed transducer assembly or unit, transducer assembly 900 may include a sealed housing 904 that defines an interior cavity and a single opening 912 from the interior cavity to the ambient environment for the output of sound. In some aspects, transducer assembly 900 may be a MEMS electro-acoustic transducer such a speaker which converts electrical signals into an audible output that can be output from a device within which transducer assembly 900 is integrated. In other aspects, transducer assembly 900 may convert sound into an electrical audio signal, and may be referred to as a microphone. Enclosure or housing 904 may be a relatively rigid structure that supports and/or encloses some or all of the acoustic components. Housing 904 may, in some cases, include a number of walls or portions that are sealed together to create a cavity or interior chamber for containing the transducer components. In some aspects, the portions of walls may be considered fixed structures that can be snap-fit, welded, adhered or attached in a sealed manner together using some other mechanism or process along their interfacing surfaces to form housing 904. The only opening from the interior chamber formed by housing 904 to the ambient environment may be opening 912. Opening 912 may, in some aspects, be considered an acoustic or sound output opening that outputs sound (as indicated by the arrow) generated by the transducer to the surrounding ambient environment (e.g., to the listener). The interior cavity therefore provides an acoustic pathway for sound generated by the transducer components to the ambient environment through opening 912 and may be considered a front volume chamber. In some aspects, the entire cavity may be considered a front volume chamber, and a back volume chamber or separate acoustic chamber behind the transducer components, may be omitted.

The sound output through opening 912 may be generated by a number of beams 906, 908, 910, 912 suspended within the interior chamber of housing 904 using ultrasonic modulation/demodulation techniques. Beams 906-912 may be similar to the beams previously discussed in reference to FIGS. 1-8, except in this configuration, beams 906-912 may be arranged such that their radiating surfaces run parallel to the axis 902 through opening 912. In addition, it is contemplated that more or fewer than the number of beams 906-912 shown may be used, and they may all share the same interior cavity and output sound through the same opening 912. Representatively, as can be further understood from FIGS. 10-11, each of beams 906-912 may have a fixed portion 906A, 908A, 910A, 912A attached to one of a top or bottom wall 904A, 904B, and a free portion 906B, 908B, 910B, 912B that is free to deflect, deform or otherwise move relative to housing 904 to produce a sound output. In some aspects, one or more of beams 906-912 may be considered a carrier beam that is only responsible for generating a single frequency (e.g., the carrier frequency). The other one or more of beams 906-912 may be considered a modulator beam that is free to generate other frequencies. An excursion clearance is provided around beams 906-912 as previously discussed so that when one or more of beams 906-912 are energized, they can achieve the desired amount of excursion (e.g., within microns) to produce sound using ultrasonic modulation/demodulation techniques without contacting one another and/or the interior surface of housing 904.

Representatively, FIG. 10 and FIG. 11 illustrate beams 906-912 arranged parallel to radiation axis 902 and having fixed ends 908A-912A attached to top or bottom wall 904A, 904B and free ends 906B-912B. Representatively, beams 906 and 910 may have their fixed ends 906A, 910A attached to bottom wall 904B and free ends 906B, 910B extending toward top wall 904A. Beams 908 and 912 may have their fixed ends 908A, 912A attached to top wall 904A and their free ends 908B, 912B extending toward bottom wall 904B. Beams 906-912 may be energized causing their free ends 906B-912B to deflect toward or away from one another to compress or expand the air cavities between the beams as shown in FIGS. 10-11. The air between beams 906-912 is pressurized as the beams deform as shown. In some aspects, beams 906-912 may be alternating carrier and modulator beams they can achieve the desired amount of excursion (e.g., within microns) to produce sound using ultrasonic modulation/demodulation techniques as previously discussed. Beams 906-912 may be bimorph piezoelectric beams (e.g., KNN and silicon beams) or electrostatic beams as previously discussed. It should further be understood that while four beams 906-912 are shown, any number of beams are contemplated.

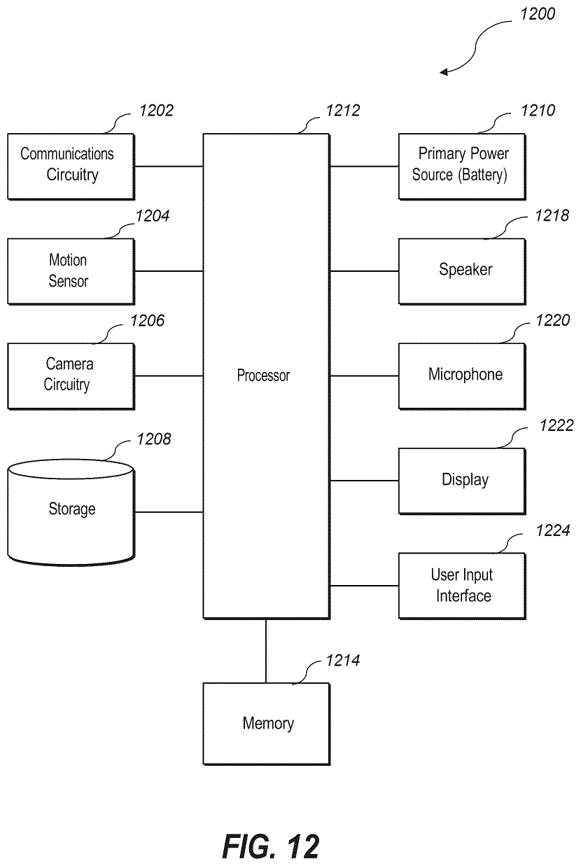

Referring now to FIG. 12, FIG. 12 illustrates a block diagram of some of the constituent components of an aspect of an electronic device in which one or more aspects may be implemented. Device 1200 may be any one of several different types of consumer electronic devices. For example, device 1200 may be any transducer-equipped device, such as an earpiece including an in-ear, an on-ear and/or an extra-aural earpiece, a cellular phone, a smart phone, a media player, a tablet-like portable computer, a controller or any other device which may benefit from a transducer assembly as disclosed herein.

In this aspect, electronic device 1200 includes a processor 1212 that interacts with camera circuitry 1206, motion sensor 1204, storage 1208, memory 1214, display 1222, and user input interface 1224. Main processor 1212 may also interact with communications circuitry 1202, primary power source 1210, motion sensor 1204, speaker 1218 and microphone 1220. The various components of the electronic device 1200 may be digitally interconnected and used or managed by a software stack being executed by the processor 1212. Many of the components shown or described here may be implemented as one or more dedicated hardware units and/or a programmed processor (software being executed by a processor, e.g., the processor 1212).

The processor 1212 controls the overall operation of the device 1200 by performing some or all of the operations of one or more applications or operating system programs implemented on the device 1200, by executing instructions for it (software code and data) that may be found in the storage 1208. The processor 1212 may, for example, drive the display 1222 and receive user inputs through the user input interface 1224 (which may be, for example, a trackpad that operates as a single, touch sensitive display panel). In addition, processor 1212 may send an audio signal to speaker 1218 and/or motion sensor 1204 to facilitate operation of speaker 1218 and/or actuator 1204.

Storage 1208 provides a relatively large amount of “permanent” data storage, using nonvolatile solid state memory (e.g., flash storage) and/or a kinetic nonvolatile storage device (e.g., rotating magnetic disk drive). Storage 1208 may include both local storage and storage space on a remote server. Storage 1208 may store data as well as software components that control and manage, at a higher level, the different functions of the device 1200.

In addition to storage 1208, there may be memory 1214, also referred to as main memory or program memory, which provides relatively fast access to stored code and data that is being executed by the processor 1212. Memory 1214 may include solid state random access memory (RAM), e.g., static RAM or dynamic RAM. There may be one or more processors, e.g., processor 1212, that run or execute various software programs, modules, or sets of instructions (e.g., applications) that, while stored permanently in the storage 1208, have been transferred to the memory 1214 for execution, to perform the various functions described above.

The device 1200 may include communications circuitry 1202. Communications circuitry 1202 may include components used for wired or wireless communications, such as two-way conversations and data transfers. For example, communications circuitry 1202 may include RF communications circuitry that is coupled to an antenna, so that the user of the device 1200 can place or receive a call through a wireless communications network. The RF communications circuitry may include a RF transceiver and a cellular baseband processor to enable the call through a cellular network. For example, communications circuitry 1202 may include Wi-Fi communications circuitry so that the user of the device 1200 may place or initiate a call using voice over Internet Protocol (VOIP) connection, transfer data through a wireless local area network.

The device 1200 may include a microphone 1220. Microphone 1220 may be an acoustic-to-electric transducer or sensor that converts sound in air into an electrical signal. The microphone circuitry may be electrically connected to processor 1212 and power source 1210 to facilitate the microphone operation (e.g., tilting).

The device 1200 may include a motion sensor 1204, also referred to as an inertial sensor, that may be used to detect movement of the device 1200. The motion sensor 1204 may include a position, orientation, or movement (POM) sensor, such as an accelerometer, a gyroscope, a light sensor, an infrared (IR) sensor, a proximity sensor, a capacitive proximity sensor, an acoustic sensor, a sonic or sonar sensor, a radar sensor, an image sensor, a video sensor, a global positioning (GPS) detector, an RF or acoustic doppler detector, a compass, a magnetometer, or other like sensor. For example, the motion sensor 1204 may be a light sensor that detects movement or absence of movement of the device 1200, by detecting the intensity of ambient light or a sudden change in the intensity of ambient light. The motion sensor 1204 generates a signal based on at least one of a position, orientation, and movement of the device 1200. The signal may include the character of the motion, such as acceleration, velocity, direction, directional change, duration, amplitude, frequency, or any other characterization of movement. The processor 1212 receives the sensor signal and controls one or more operations of the device 1200 based in part on the sensor signal.

The device 1200 also includes camera circuitry 1206 that implements the digital camera functionality of the device 1200. One or more solid state image sensors are built into the device 1200, and each may be located at a focal plane of an optical system that includes a respective lens. An optical image of a scene within the camera's field of view is formed on the image sensor, and the sensor responds by capturing the scene in the form of a digital image or picture consisting of pixels that may then be stored in storage 1208. The camera circuitry 1206 may also be used to capture video images of a scene. Device 1200 also includes primary power source 1210, such as a built in battery, as a primary power supply.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A microelectromechanical transducer assembly comprising:
an enclosure defining an interior chamber and an opening from the interior chamber to a surrounding ambient environment;
a first sound radiating member operable to produce a first frequency; and
a second sound radiating member arranged parallel to the first sound radiating member and operable to produce a second frequency that in combination with the first frequency generates an audible sound output.

2. The microelectromechanical transducer assembly of claim 1 wherein each of the first sound radiating member and the second sound radiating member comprise a cantilever beam having a first end attached to an interior surface of the enclosure and a second end that is operable to deform to produce the first frequency or the second frequency.

3. The microelectromechanical transducer assembly of claim 1 wherein the first sound radiating member comprises a carrier beam that produces only the first frequency.

4. The microelectromechanical transducer assembly of claim 3 wherein the first frequency comprises a carrier frequency within an ultrasonic frequency range.

5. The microelectromechanical transducer assembly of claim 1 wherein the second sound radiating member comprises a modulator beam and the second frequency comprises a modulator frequency that is different from the first frequency.

6. The microelectromechanical transducer assembly of claim 1 wherein at least one of the first sound radiating member or the second sound radiating member comprises a piezoelectric beam.

7. The microelectromechanical transducer assembly of claim 6 wherein the piezoelectric beam comprises a first passive layer comprising silicon and a second active layer comprising potassium sodium niobate.

8. The microelectromechanical transducer assembly of claim 6 wherein the at least one of the first sound radiating member or the second sound radiating member comprises a sound radiating surface that runs perpendicular to an axis through the opening.

9. The microelectromechanical transducer assembly of claim 1 wherein at least one of the first sound radiating member or the second sound radiating member comprises an electrostatic plate.

10. The microelectromechanical transducer assembly of claim 9 wherein the electrostatic plate comprises a number of arms extending from a perimeter of the electrostatic plate and the number of arms attach the electrostatic plate to an interior surface of the enclosure.

11. The microelectromechanical transducer assembly of claim 1 wherein the at least one of the first sound radiating member or the second sound radiating member comprises a sound radiating surface that runs parallel to an axis through the opening.

12. The microelectromechanical transducer assembly of claim 1 wherein the enclosure defines a first transducer unit comprising the first sound radiating member and the second sound radiating member, and the first transducer unit is part of an array of other transducer units that generate an audible sound output.

13. The microelectromechanical transducer assembly of claim 1 wherein the opening is an only opening from the interior chamber to the surrounding ambient environment.

14. An electronic device comprising:
a microelectromechanical transducer assembly having enclosure defining an interior chamber and an opening from the interior chamber to a surrounding ambient environment;
a first sound radiating member operable to produce a first frequency; and
a second sound radiating member arranged parallel to the first sound radiating member and operable to produce a second frequency that in combination with the first frequency generates an audible sound output.

15. The electronic device of claim 14 wherein each of the first sound radiating member and the second sound radiating member comprise a beam having a first end attached to an interior surface of the enclosure and a second end that is operable to deform to produce the first frequency or the second frequency.

16. The electronic device of claim 14 wherein the first sound radiating member comprises a carrier beam that produces only the first frequency within an ultrasonic frequency range.

17. The electronic device of claim 16 wherein the second sound radiating member comprises a modulator beam and the second frequency comprises a modulator frequency that is different from the first frequency.

18. The electronic device of claim 14 wherein at least one of the first sound radiating member or the second sound radiating member comprises a piezoelectric beam having a sound radiating surface that runs perpendicular to an axis through the opening.

19. The electronic device of claim 14 wherein at least one of the first sound radiating member or the second sound radiating member comprises an electrostatic plate having a number of arms extending from a perimeter of the electrostatic plate.

20. The electronic device of claim 14 wherein the microelectromechanical transducer assembly is a first microelectromechanical transducer assembly that is part of an array of other microelectromechanical transducer assemblies that are combined to generate an audible sound output.
